(19) United States
(12) Patent Application Publication
(10) Pub. No.: US 2017/0352029 A1
(43) Pub. Date: Dec. 7, 2017

(54) Payment data collection method and apparatus connected to a cloud platform

(71) Applicant: Sandhya Kalkunte, Lexington, MA (US)

(72) Inventor: Sandhya Kalkunte, Lexington, MA (US)

(21) Appl. No.: 15/493,134

(22) Filed: Apr. 21, 2017

Related U.S. Application Data
(60) Provisional application No. 62/325,108, filed on Apr. 20, 2016.

(51) Int. Cl. G06Q 20/38; G06Q 20/08; G06Q 20/40; H04L 29/06

(52) U.S. Cl. CPC G06Q 20/382; H04L 63/08; G06Q 20/0855; G06Q 20/401

(57) ABSTRACT

A payment data collection method and Apparatus connected to a cloud platform that is scalable and configurable to include: a point-of-sale (POS) device having a customer interfaced form connected to a cloud platform facilitating data encryption and storage on the cloud platform, generation of a unique code by the cloud platform after receipt of purchase details, an electronic processor at point-of-sale that receives the unique code and affixes it to a sale receipt generated after payment is processed by a connected payment processor. The method of the present invention utilizes a form at a POS location to receive sufficient purchase information necessary to generate a unique code, benchmarked by a monitoring authority for a specific business enterprise or specific business location, while processing payment and generating a sale receipt affixed with the unique code to the consumer. An Apparatus connected to a cloud platform at a location has payment data entered into a form on a point-of-sale device with encryption capability connected to a cloud platform, an electronic processor to receive a unique code, process payment, generate sale receipt with the unique code, and may also contain a scanner to scan and store the sale receipt on the cloud platform. Among other embodiments of the present invention, the cloud platform could be a network between a business enterprise and a government authority to seamlessly provide specific purchase information only due to high transaction volume including tax details in encrypted form from the business enterprise to the government authority on the cloud platform, a unique code generated by the government authority to be transmitted to the electronic processor of the present invention, and the unique code affixed to a sale receipt after payment is processed by the payment processor.

### FIELD OF INVENTION

Electronic payment processing systems that encrypt sale and tax details for storage on cloud databases, networked to monitoring authority databases that provide benchmarked unique codes affixed to customer sale receipts for each sale from a business enterprise or business location

### BACKGROUND OF THE INVENTION

In the current high-technology environment, millions to trillions of dollars of revenue is lost by businesses and government bodies due to electronic sale suppression by Phantom ware, Zappers etc. due to local storage of point-of-sale (POS) data even if encrypted and only unlocked by special debit/credit card type or government approved card swipes using locally configured payment apparatuses. Also, due to high volume of transactions throughout a specific audit period, it is very cumbersome to retrieve data stored off-line, using e-auditors or Electronic Commerce Audit Specialists (ECAS). The POS systems often contain thousands of transactions making it impossible to audit without using Computer Assisted Audit Tools and Techniques (CAATTs) such as IDEA, ACL or SESAM. The selection of data files for audit is not straight forward, especially when a business uses a Hybrid system, as opposed to a PC-based POS system. Further, businesses provided special incentives or reimbursements on sales by local jurisdictions, government entities or authorized third parties receive incentives only after an audit process or tax reporting is completed, thus affecting their profit margins near term. Furthermore, without proper real-time encryption and transmission of sales data, suppression of sale can be easily done locally offline or with sophisticated software or other digital intermediaries. Ultimately, there is a need to provide a code from an authority signifying to consumer the authenticity of a sale for record keeping purposes that may be easily verifiable against any bank or credit card transaction using sufficient card or check information without compromising the privacy of the consumer.

### BRIEF SUMMARY OF THE INVENTION

The payment data collection method and Apparatus of the present invention may be scalable and configurable to include a customer interfaced point-of-sale device with a form networked to a cloud platform to receive details of a particular sale transaction submitted as form inputs by the customer, stored as encrypted data on the cloud platform, to generate a unique code received from the cloud platform to be affixed to a sale receipt after payment by the customer is processed.

One use of the present invention maybe medical reimbursement monitored at point of sale of pharmaceutical drugs. Another use may be to optimize incentives by government authorities to enterprise businesses for conforming to tax data collection protocols in real-time that may facilitate revenue collection at point-of-sale with minimal electronic suppression. Yet another use may be to streamline audit processes and project the optimal tax revenue streams accompanying certain sales by consumers within certain jurisdictions, for example, states, municipalities, cities or foreign entities dealing with the same enterprise business. Further use may be in the export/import duty collection process.

### BRIEF DESCRIPTION OF THE DRAWINGS

FIG. 1 is a block diagram of the payment system of the present invention.

FIG. 2 is a block diagram of one embodiment of the payment system shown in FIG. 1, showing the cloud platform constituting a cloud network between a business enterprise and a government authority.

### DETAILED DESCRIPTION OF THE INVENTION

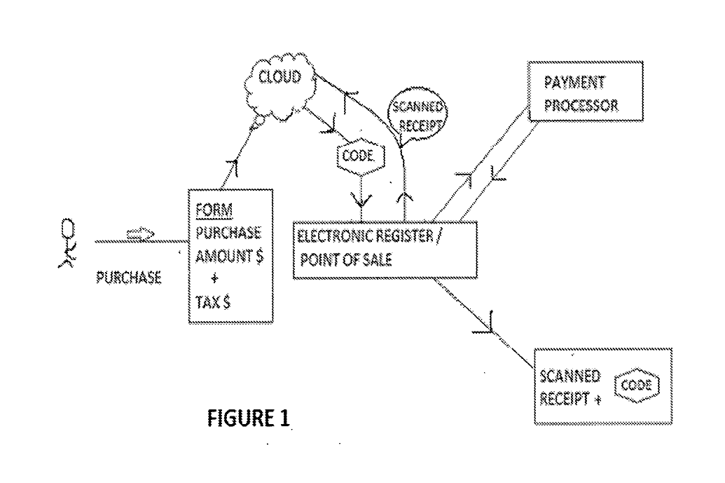

A payment data collection method and Apparatus wherein the information on a payment is received using the apparatus of the system connected to a cloud platform through available network systems, such as Wi-Fi, GPRS, or other internet connection option known in the art to connect to a cloud platform. In the main embodiment of the present invention as shown in FIG. 1, the payment data collection method and Apparatus include: a customer interfaced point-of-sale device with a form networked to a cloud platform to receive details of a particular purchase transaction submitted as form inputs by the customer, stored as encrypted data on the cloud platform, and that in turn generates a unique code to be affixed to a sale receipt after payment by the customer is processed.

The cloud platform stores the data using a location or business identification number issued by a monitoring authority such as a government or enterprise department for keeping track of payments received by each business location. Also, the cloud platform is uniquely benchmarked to each business as a single enterprise or by business location, depending upon the size of the business. Further, the POS system used by the business enterprise is easily identifiable by the cloud platform. Also further, the POS locality of the business, or address for delivery of sale goods for internet sales, with accompanying tax or other sale information is appropriately documented by the business enterprise to document the sale for bookkeeping, accounting and/or audit purposes. Furthermore, the connection between the POS system and the cloud platform is encrypted to keep real-time purchase information unalterable by the business or third parties. As mentioned earlier, the POS system generating the payment data may be at a location, for example, an internet POS system connected through a business enterprise website or kiosk to the cloud platform or connected to the cloud platform at a local retail facility.

In the present invention, the cloud platform receives data pertaining to: time and date stamp, type of purchase, purchase price, address of point of sale and/or delivery due to remote sales to consumer, applicable sales tax information, sufficient payment instrument information, and or optionally tips received on a valid signed sale receipt from a customer. A unique confirmation code is then generated and sent to the Apparatus of the invention fitted with a receiver called the electronic register, well known in the art, at point of sale or POS. The cloud platform may generate a unique code with just a few of the payment data mentioned earlier in the form of raw information or special coded information deemed useful by the monitoring authority. Then the electronic register in turn signals to one or a combination of payment devices to accept payment and create a sale receipt having the unique code. The sale receipt with the unique code may be scanned by the apparatus of the present invention and transmitted to the encrypted cloud platform for storage and/or printed for the benefit of the consumer.

In another embodiment of the present invention, the cloud platform has a unique cloud storage identifier for each business, equipped to provide business specific reimbursement or token payments for portion of the reported sale in a seamless manner, either overnight or in a time frame reasonably negotiated between the parties. Further, the cloud platform is equipped with software to recognize re-sales exempt by local government jurisdictions or business enterprise departments such as “exempt use certificates” issued by states or special intra-business network promotions, so that only final sale to consumer is monitored and a unique code is provided to affix on a sale receipt or invoice provided to consumer.

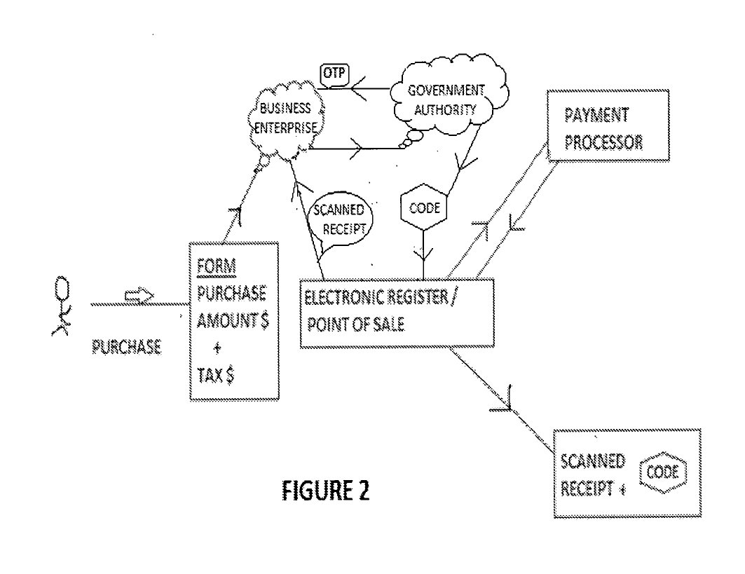

In an embodiment of the cloud platform of the present invention as shown in FIG. 2, the cloud platform may be a networked series of cloud databases, one of which is an enterprise business cloud platform that sends sufficient encrypted real-time POS information to the cloud platform maintained by a monitoring authority such as a tax authority, export or import duty collection authority, local municipality or foreign entity. This configuration of the cloud platform of the present invention may be necessary due to the volume of transactions in real-time with most of the payment information stored in the enterprise business cloud and sufficient information simultaneously sent in real-time from POS through the enterprise business cloud platform to the cloud platform of the monitoring authority that eventually generates the necessary unique code for processing payments made by a consumer.

As shown in FIG. 2, the enterprise business may be provided access to the data stored by the government authority in the cloud platform using one-time passwords (OTP) after their accounting or bookkeeping division verifies certain business related identifiers. Also, the enterprise business may use an account and password combination and/or swipable card to unlock the information saved in the encrypted cloud platform. By doing so, the enterprise business may see how much after tax profit was generated using the method and apparatus of the present invention.

Further, in one other embodiment of the present invention, the confirmation code is transmitted to the Apparatus of the invention after payment is completed either online or at point-of-sale and the code is affixed on a scanned sale receipt. In yet another embodiment of the current invention, only the original input at point-of-sale with data pertaining to: time and date of sale, type of purchase, purchase price, address of point of sale and/or delivery due to remote sales to consumer, applicable sales tax information, sufficient payment instrument information etc., is stored and a unique code is generated and transmitted to the Apparatus of this invention after full payment is processed, indicating completion of payment by consumer. In a further embodiment of the present invention, a business may transmit a sale of goods or service with the above mentioned information on behalf of a supplier who directly delivers to a consumer a finished product in the ordinary course of business with the necessary certification issued by tax authorities.

The payment data collection method of the present invention utilizes the Apparatus alone or in combination with one or more separate monitoring instruments that have the capability to be networked to a cloud platform having sufficient encryption required for keeping information unaltered and private. The encryption process may be essential for the business and the branch of government monitoring it.

The Apparatus of the invention is a single or multiple unit system where the number of units of the Apparatus is around about 1 to 10. The Apparatus of the invention has a network capability to be detected by a cloud service from a remote location using a Wi-Fi, cable or other network system currently available. For purposes of this invention, the Wi-Fi or network system may be provided by an internet service provider providing access to the cloud platform. Also, the Apparatus has a computerized form which is filled with at least a purchase price and purchase type prior to being submitted to the cloud service. Further, the Apparatus has the capability of printing a sale receipt with a unique code, date, time, allowed payment instrument number, payment type, customer name, business or location name, address, contact information or identification number. Also further, the Apparatus may have a built in camera or other scanning capability to upload image of a payment sale receipt to the connected network and into the cloud platform for further storage.

1. A payment data collection method wherein the payment data received from purchaser is entered into an electronic form connected to a cloud platform to generate a unique code from the cloud platform, and sent to a payment monitoring devise.

2. The method as in claim 1, further comprising receipt of a unique code from the cloud platform by a payment monitoring devise to complete payment processing.

3. The method as in claim 1, further comprising receipt of a unique code from the cloud platform by a payment monitoring devise, and generating a payment receipt with the unique code.

4. The method as in claim 1, further comprising receipt of a unique code from the cloud platform by a payment monitoring devise to complete payment processing at point-of-sale, and generating a payment receipt with the unique code.

5. The method as in claim 1, further comprising receipt of a unique code from the cloud platform by a payment monitoring devise to complete payment processing at point-of-sale, generating a payment receipt with the unique code and scanning the payment receipt with the unique code for electronic storage.

6. An Apparatus for collecting payment data comprising of an electronic form and a payment monitoring devise connected to a cloud platform wherein the payment data is sent to the cloud platform through the electronic form, and the cloud platform sends a unique code to the payment monitoring devise to complete payment.

7. The Apparatus as in claim 6, further comprising a payment processor at point-of-sale.

8. The Apparatus as in claim 6, further comprising a payment processor and a payment receipt generator at point-of-sale.

9. The Apparatus as in claim 6, further comprising a payment processor, a payment receipt generator and a payment receipt scanner at point-of-sale.
